(19) United States
(12) Patent Application Publication
(10) Pub. No.: US 2011/0069600 A1
(43) Pub. Date: Mar. 24, 2011

(54) OPTICAL RECORDING-REPRODUCING APPARATUS

(75) Inventor: Toshihiko Suzuki, Yokohama-shi (JP)

(73) Assignee: CANON KABUSHIKI KAISHA, Tokyo (JP)

(21) Appl. No.: 12/994,509

(22) PCT Filed: May 18, 2009
(86) PCT No.: PCT/JP2009/059469

§ 371 Date: Nov. 24, 2010

(30) Foreign Application Priority Data
May 28, 2008 (JP) 2008-139675

(51) Int. Cl. G11B 7/135

(52) U.S. Cl. 369/112.23; G9B/7.121

(57) ABSTRACT

An optical recording-reproducing apparatus includes a laser light source, an objective lens for concentrating a luminous flux from the laser light source onto a disk medium, an actuator for controlling the position of the objective lens, a tilt-adjusting circuit for adjusting a tilt of the objective lens with respect to the disk medium, a circuit for determining laser power for recording a recording mark on the disk medium, and a circuit for detecting symmetry of the recording mark based on reflected light from the disk medium. In recording, the tilt of the objective lens is adjusted by the tilt-adjusting circuit based on an amount of change of the symmetry of the recording mark.

This application is a U.S. national stage application of PCT International Application No. PCT/JP2009/059469, filed May 18, 2009, published as PCT Publication No. WO 2009/145122 A1, on Dec. 3, 2009, and which claims priority from Japanese patent application number 2008-193675, filed May 28, 2008, which is hereby incorporated by reference in its entirety.

### TECHNICAL FIELD

The present invention relates to an optical recording-reproducing apparatus that uses laser light to perform one of recording of information on and reproduction of information from a disk medium, and, more particularly, to an apparatus having a tilt compensation mechanism and performing improved information-recording operations by using the tilt compensation mechanism.

### BACKGROUND ART

In the recent environment, in which a huge number of inexpensive disk media are supplied, it has become necessary for optical recording-reproducing apparatuses to cover the composition and individual variability of disk media sufficiently. The composition of media, including the track width, pitch, groove shape, material of a recording film, and film evenness in the radial direction, mainly depends on specifications of each manufacturer. As to the individual variability of media, differences in characteristics are seen even among media from the same manufacturer, for reasons such as different manufacturing lots.

Particularly, due to the use environment and maintenance environment for a medium and changes in the medium over time, a warp (hereafter referred to as a “tilt”) occurs in the disk medium. This tilt significantly affects the quality of recording signals. The effect of the tilt causes an increase of a wave aberration of a light beam spot. The relationship between the tilt and the wave aberration will be described with reference to FIG. 5.

In FIG. 5, the abscissa indicates the amount of tilting degrees in the direction of the disk radius, and the ordinate indicates the intensity of reflected light of a light beam spot. This example illustrates a characteristic of an optical pickup with an objective lens (NA) of 0.6 and a light-emitting laser wavelength of 660 nm. It is shown that, when the intensity of the reflected light with no tilt on the disk is 1, the intensity of the reflected light is 0.8, when the amount of tilting is 0.4 degrees. That is, the intensity decreases by as much as 20%. In this manner, the tilt increases the wave aberration to degrade the quality of the light beam spot. This means that the signal quality itself in recording is compromised. As an attempt to compensate for this wave aberration effect with the recording-power intensity, Japanese Patent Application Laid-Open No. H06-295458, Japanese Patent Application Laid-Open No. 2002-3139135, and Japanese Patent Application Laid-Open No. 2007-149238 are known.

Japanese Patent Application Laid-Open No. 06-295458 describes a technique in which a tilt sensor is provided on an optical pickup to detect the amount of tilting of a disk medium. The laser-power intensity for recording is controlled according to the detected amount of tilting.

Japanese Patent Application Laid-Open No. 2002-319135 describes a technique in which a tilt is detected by providing a step of detecting the physical state of a disk surface based on a reproduction signal from the disk. The laser-power intensity for recording is controlled according to the detected physical state.

Japanese Patent Application Laid-Open No. 2007-149238 discusses a technique in which the temperature near a laser light source is monitored. If a predetermined temperature change is observed, a recording operation is paused to measure a β value of an immediately preceding recording mark. Based on the difference from a target β value, a recording strategy is optimized. The β value here is an index indicating the asymmetry of a reproduction signal and is calculated from a peak voltage (A) and a bottom voltage (B) of the reproduction signal as:

β=(A+B)/(A−B).

However, the above conventional techniques have had problems as follows. The technique described in Japanese Patent Application Laid-Open No. H06-295458 requires providing the tilt sensor on the optical pickup. This leads to increases in size and cost of the optical pickup. Further, the recording power is changed according to the detected amount of tilting. Therefore, for example, heat may be generated when the recording power is corrected to be increased. In a densely packed housing, this may invite a thermal runaway of the system.

The technique described in Japanese Patent Application Laid-Open No. 2002-319135 also causes an increase in size, because a tilt sensor is provided. The recording power is corrected according to the quality of the reproduction signal instead of the tilt sensor. However, a problem of oversupplying the recording power according to the amount of tilting still remains.

The technique described in Japanese Patent Application Laid-Open No. 2007-149238 corrects the recording power by monitoring temperature changes near the laser to determine a change of the β value of the reproduction signal. However, it is difficult to compensate for the tilt with appropriate timing based on a temperature change near the laser. This is because there is a low correlation between the fact that the disk is (or was) warped and the temperature (around the laser) at the time of warpage.

### DISCLOSURE OF THE INVENTION

An object of the present invention is to provide an optical recording-reproducing apparatus in which a tilt that occurs during recording can be appropriately compensated for, while requiring no specially provided sensor, and reducing the effect of heat inside the apparatus caused by recording power.

The present invention is directed to an optical recording-reproducing apparatus, comprising:

a laser light source;

an objective lens for concentrating on a disk medium a luminous flux from the laser light source;

an actuator for controlling the position of the objective lens;

a tilt-adjusting circuit for adjusting a tilt of the objective lens with respect to the disk medium;

a circuit for determining laser power for recording a recording mark on the disk medium; and

a circuit for detecting symmetry of the recording mark based on reflected light from the disk medium,

wherein, in recording, the tilt of the objective lens is adjusted by the tilt-adjusting circuit based on an amount of change of the symmetry of the recording mark.

The tilt of the objective lens can be adjusted by the tilt-adjusting circuit if the amount of change of the symmetry of the recording mark is larger than a predetermined value.

The optical recording-reproducing apparatus can comprise:

a circuit for obtaining a focus driving signal for the disk medium,

wherein a direction of a tilt of the disk medium is detected based on the focus driving signal, and the tilt of the objective lens is adjusted by the tilt-adjusting circuit based on the detection result.

The optical recording-reproducing apparatus can comprise:

a memory for holding information, in order to cause recording or reproduction of the recording mark on the disk medium to be intermittently operated,

wherein the circuit for detecting the symmetry of the recording mark detects the symmetry in synchronization with the intermittent operation.

As described above, against miniaturization of the apparatus and extreme dynamically varying factors arising in the use in a mobile environment, the present invention advantageously appropriately compensates for a tilt that occurs during recording.

Particularly, a tilt that occurs in a disk medium due to the use environment and maintenance environment for the medium, and changes in the medium over time, is unpredictable. However, the tilt adjusting mechanism of the present invention allows transitioning to tilt adjusting with appropriate timing. Further, unlike the conventional techniques, no tilt sensor needs to be provided, and the recording power is not oversupplied. That is, the increase of the recording power due to a tilt can be restrained even in a densely packed small housing, which advantageously allows the power consumption to be saved and the amount of heat in the entire system to be kept small.

Eventually, the beam-spot quality in recording can be advantageously maintained in a good state at all times.

Further features of the present invention will become apparent from the following description of exemplary embodiments with reference to the attached drawings.

### BRIEF DESCRIPTION OF THE DRAWINGS

FIG. 1 is a function block diagram of an optical recording-reproducing apparatus.

FIG. 2 is a flowchart illustrating operations according to a first embodiment of the present invention.

FIG. 3 is a flowchart illustrating operations according to a second embodiment of the present invention.

FIG. 4 is a diagram describing tilt adjusting.

FIG. 5 is a diagram describing the effect of an aberration due to a tilt.

FIG. 6 is a diagram describing the relationship between a β value of a reproduction signal and the recording quality (jitter).

FIG. 7 is a diagram describing an overall operation flow in the first embodiment according to the present invention.

FIGS. 8A and 8B are diagrams describing the average level of a focus driving signal.

FIG. 9 is a diagram describing actuator control signals.

FIG. 10 is a tilt compensation table according to the second embodiment of the present invention.

FIGS. 11A and 11B are diagrams describing the structure of an actuator.

Unless otherwise specified, reference numerals in the drawings are defined as follows:
101 optical disk;
102 objective lens;
103 actuator;
104 optical system;
105 LD/driver;
106 reproduction signal sensor;
107 LD power monitoring sensor;
108 temperature sensor;
109 SPM control;
110 SPM;
111 power control;
112 feed mechanism;
113 actuator driver;
114 servo recording-reproducing processor;
115 disk controller;
116 external interface; and
117 memory.

### BEST MODES FOR CARRYING OUT THE INVENTION

Exemplary embodiments of the present invention will be described in detail below with reference to the drawings.

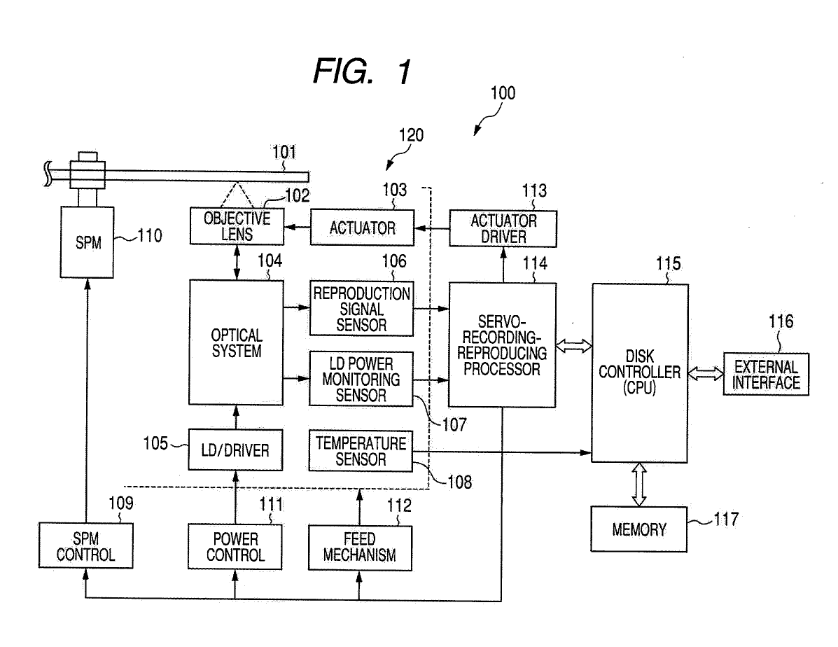

Tilt adjusting according to the present invention is carried out by observing the amount of change of the β value resulting from reproducing a recording mark recorded on a disk medium. This tilt adjusting is carried out in an optical recording-reproducing apparatus 100, as shown in FIG. 1.

As described in the Background Art, the β value is an index indicating the asymmetry of a reproduction signal and is calculated from a peak voltage (A) and a bottom voltage (B) of the reproduction signal as β=(A+B)/(A−B).

### <Components and Series of Operations in Optical Recording-Reproducing Apparatus 100>

The optical recording-reproducing apparatus 100 includes an optical disk (hereafter referred to as a “disk”) 101, and an optical pickup (hereafter referred to as an “SPM”) 110. The optical recording-reproducing apparatus 100 further includes a spindle motor control (hereafter referred to an “SPM control”) 109, a power control 111, an actuator driver 113, a feed mechanism 112, a servo recording-reproducing processor 114, and a disk controller (CPU) 115.

The general configuration and basic operation in FIG. 1 will be described.

The disk controller 115 includes a CPU (Central Processing Unit). A user-specified command or a predetermined program is executed from an operation system (not shown) via an external interface 116 to control the operation of the entire optical recording-reproducing apparatus 100. In the operation of recording onto or reproducing from a disk, well-known shockproof (intermittent driving) control is performed through memory 117.

The disk 101 is, for example, a phase-change type disk having a phase-change material, such as Ge—Sb—Te, on a recording layer. When the disk is irradiated with a light beam with its intensity modulated while the disk is rotated, the state reversibly changes between an amorphous state and a crystalline state. To change the recording layer from the crystalline state to the amorphous state, the light beam (a luminous flux) is emitted on a pulse to melt the recording layer, which is then rapidly cooled down. On the other hand, to change the recording layer from the amorphous state to the crystalline state, laser light of a relatively weak light-beam intensity is emitted to anneal the recording layer at a temperature not lower than a crystallization temperature. The disk 101 is characterized by the ability to store 1 or 0 information as a state change by utilizing such a phase-change characteristic.

The disk 101 may be a disk of a write-once type having an organic dye on the recording layer. In the case of the write-once type, a strong light beam emitted at the time of recording is absorbed in a dye film and causes thermal alteration to change the reflectance of the medium. Disks of this type allow recording only once, but the demand is rapidly spreading, because of the high reproduction compatibility among players and relatively low prices.

Now, servo recording-reproducing processing by the disk controller 115 and the servo recording-reproducing processor 114 will be described. The servo recording-reproducing processor 114 controls rotational driving of the spindle motor (SPM) 110 through the SPM control 109. Here, the rotation of the spindle motor is controlled according to what is called CLV (Constant Linear Velocity). The disk 101 has meandering walls called wobbles formed thereon along track grooves. The disk rotation speed is controlled so that the frequency of a wobble in question becomes equal to a target value.

The OPU 120 includes an objective lens 102, an actuator 103, an optical system 104, an LD/driver 105, a reproduction signal sensor 106, and LD power monitoring sensor 107, and a temperature sensor 108. The OPU 120 is connected to the servo recording-reproducing processor 114 or to a motor and actuator driver system by flexible cables.

The LD/driver 105 is a semiconductor laser device (hereafter referred to as an “LD”) and a laser driver. Laser light emitted from the LD is concentrated on the disk 101 through the optical system 104 and the objective lens 102. The LD power monitoring sensor 107 includes a semiconductor light-receiving sensor and a photoelectric conversion amplifier. Part of the laser light emitted from the LD goes through the LD power monitoring sensor 107, which forms an APC (Auto Power Control) loop with the servo recording-reproducing processor 114 and the power control 111. That is, the LD emission power is feedback-controlled so that the output of the LD power monitoring sensor becomes equal to a target power set in the disk controller 115.

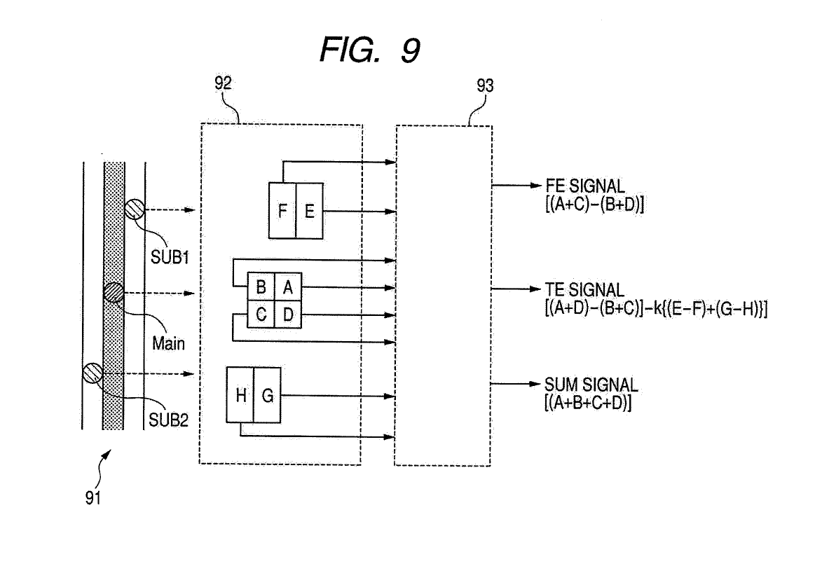

The reproduction signal sensor 106 includes a semiconductor light-receiving sensor and a photoelectric conversion amplifier. FIG. 9 illustrates the disposition of light spots on the disk, the configuration of the reproduction signal sensor, and an operation processing unit in the servo recording-reproducing processor.

In FIG. 9, a main beam Main is controlled to be positioned in the middle of a track 91. Sub-beams SUB1 and SUB2 are controlled to be positioned to be displaced by half a track in the radial direction with respect to the Main (differential push-pull).

A reproduction signal sensor unit 92 corresponds to the three beams, so that reflected light of the main beam Main is emitted into a quartered sensor (A to D) and reflected light of the sub-beams SUB1 and SUB2 is emitted into halved sensors (E to F, and G to H). Output of the reproduction signal sensor is transferred from the OPU 120 to an operation processing unit 93 in the servo recording-reproducing processor 114 via a flexible cable. In the operation processing unit, the channel signals A to H are subjected to operation processing through predetermined gain control (an auto gain control), filter processing (a pre-filter), and digitization (an analog/digital converter). Here, a SUM signal, which is the sum of the reflected light of the main beam, is calculated and output as:

SUM=A+B+C+D.

A signal of the difference between diagonal sums of the quartered sensor is calculated and output as a focus error/FE signal for the main beam (astigmatic method) as:

FE=(A+C)−(B+D).

Although a push-pull signal for the main beam is obtained as (A+D)−(B+C), this includes an offset caused by a shift of the objective lens in the direction of the disk radius. Therefore, a push-pull component (E−F)+(G−H) of the sub-beam is multiplied by a predetermined coefficient k and then subtracted to generate a track error/TE signal, in which the offset component has been canceled as:

TE=(A+D)−(B+C)−k{(E−F)+(G−H)}.

The predetermined coefficient k is a constant determined according to the ratio of divided light quantity among the main beam and the sub-beams.

Thus, based on the focus error/FE signal, focus position control (focus control) for the light beam spot is performed. Based on the tracking error/TE signal, tracking control is performed, in which the light beam spot is controlled to track in the groove direction for an information track. The tracking control is performed by fine-tuning in the actuator 103 and coarse-tuning by the feed mechanism 112. That is, when it is detected that the objective lens is placed at the end of the movable range of the actuator, the feed mechanism operates to move the entire OPU 120 in the direction of the disk radius. In this manner, the light beam spot is controlled to track a predetermined track on the disk by the combination of the fine-tuned control by the actuator and the OPU movement by the feed mechanism. The feed mechanism 112 is also responsible for a seek operation for seeking a certain address by moving the OPU 120 in the direction of the disk radius (traverse control).

The digitized reproduction signal then undergoes data processing while a PLL (Phase Locked Loop) (not shown) generates clocks synchronous with edges of the reproduction signal. Further, predetermined decoding processing, such as data detection with PRML (Partial-Response Maximum-Likelihood) and ECC (Error Correction Code), is performed.

Here, the β value of the reproduction signal detected in the servo recording-reproducing processor 114 will be described.

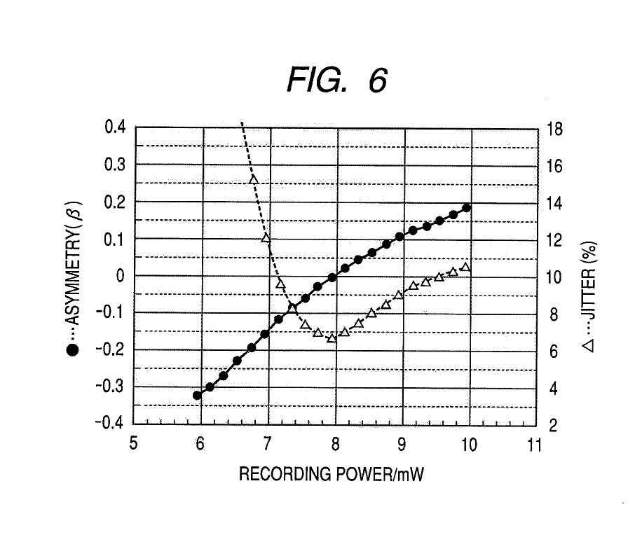

FIG. 6 illustrates the relationship between the 3 value of a reproduction signal and the quality of a recorded signal. In FIG. 6, the abscissa indicates the recording power intensity [mW], the left ordinate indicates the asymmetry (β value), and the right ordinate indicates the jitter [%]. The β value represented by black circles is strongly correlated with the recording power on the abscissa, so that the β value increases substantially linearly in proportion to the increase of the recording power. The jitter represented by white triangles is a representative index indicating the recording quality, and a jitter bottom value is obtained substantially at around a recording power of 8 [mW]. At this point, the β value for this recording power is approximately zero. This indicates that the best recording quality achieving the jitter bottom can be obtained if recording is performed by setting a recording power corresponding to a β value of zero. it can be seen that the correlation between the β value and the recording power is such that if the β value changes by 10%, the recording power also changes by 10%. A detected 3 value positively larger than the target β value means that the recording power is excessive, and a detected p value negatively larger than the target β value means that the recording power is insufficient. Processing of optimizing the recording power by using the β value in this manner is called OPC (Optimum Power Control). Trial recording is performed with a plurality of recording powers, and the recording power is set so that the β value of the reproduction signal becomes equal to the target β value.

For example, assume that data is to be recorded onto a disk having a target β value of zero, and the β value of a reproduction signal is observed as 5% in trial recording. In this case, the recording power is optimized by controlling to reduce the recording power by 5%. Since the relationship between changes of the β value and the optimum recording power does not depend on changes of the environmental temperature, the recording quality can be kept stable if the recording power is constantly controlled to match the target β value.

On the other hand, in recording onto the disk, a recording pattern is generated in the servo recording-reproducing processor 114 by modulation processing that conforms to the disk format. The LD/driver 105 is responsible for what is called a write strategy operation, in which waveform shaping and timing control for laser light-emission pulses are performed according to the recording pattern.

The disk controller 115 performs recording in a shockproof operation. Specifically, the disk controller 115 causes disk accesses to be activated intermittently, by utilizing the difference between the rate (slow) of data that is input to/output from the apparatus, and the rate (fast) of recording onto the disk. That is, disk accesses are put in an inactive state, while signals from the external interface are being accumulated in the memory 117. The inactive state means that the power-consuming LD is turned off to halt the operation of associated electric circuit blocks. Once a predetermined amount of data is accumulated in the memory 117, disk accesses are started, to perform recording from the memory 117 onto the disk 101. When the recording onto the disk is finished, disk accesses are again put in the inactive state. Intermittently performing disk accesses in this manner allows the LD to be turned off in the inactive state, and, therefore, the average power consumption can be reduced. In addition, even if a vibration or a shock is applied from the outside of the apparatus, the memory 117 serves as a buffer and enables servo recovery processing (retry reprocessing). Therefore, the quakeproof reliability is advantageously increased.

The OPU 120 is provided with the temperature sensor 108 therein and has a function of detecting the temperature near the LD through the disk controller 115.

### First Embodiment

### Tilt Adjusting Flow in Optical Recording-Reproducing Apparatus 100

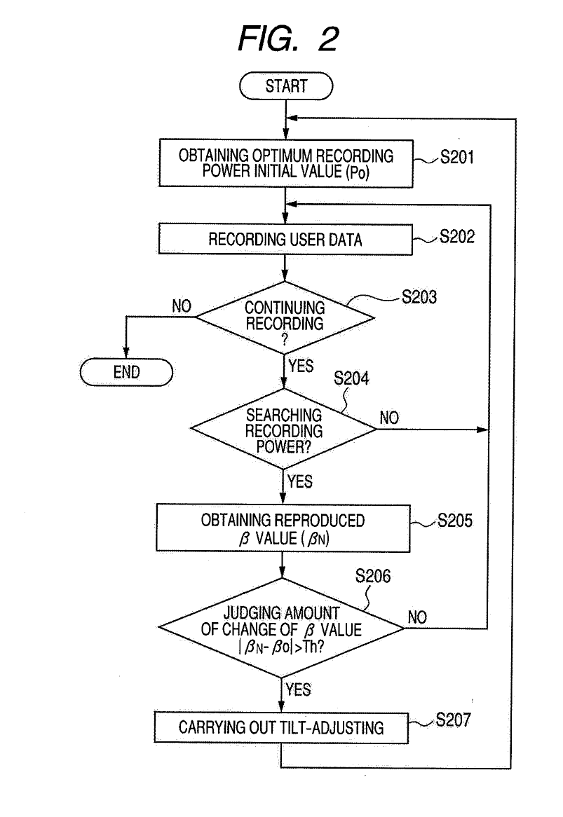

FIG. 2 is a flowchart illustrating first tilt adjusting according to the present invention. A specific adjusting flow will be described with reference to FIG. 2.

[Step S201: Obtaining an Optimum Recording Power]

This step is a process of determining an optimum recording power for the disk.

Under instructions from a higher-level command, the disk controller 115 performs the OPC (Optimum Power Control) for determining the recording laser power. Specifically, the OPU 12 is moved to a PCA (Power Calibration Area), a predetermined area on the disk, to perform trial recording and a reproduction operation. In the trial recording, the recording is performed while the recording laser power is varied in the range of several levels. In the reproduction, the recorded trial data is reproduced to obtain reproduced data for each recording laser power, and the signal quality is determined. An index of the signal quality is the β value indicating the symmetry of the amplitude of the reproduction signal. For each disk, a β value (target Bo value) at which the best recording quality is achieved is preset in the apparatus. The recording power that matches the target βo value is stored as the optimum recording power in a predetermined register. At the same time, conditions such as the time and temperature at which the OPC was performed are also maintained as property information. The disk controller 115 includes a plurality of registers and has data accesses to and an operation function on registers in question.

The execution of the OPC shown in step S201 does not necessarily require moving to the predetermined PCA area to perform the trail recording operation. That is, the trial recording may be performed in a user data area. Alternatively, prerecorded data may be reproduced to determine the β value, and the recording power may be determined so that the difference from the target βo is compensated for. Further, besides the β value, a jitter value indicating fluctuations of edges or an error rate indicating the reliability of reproduced data may be taken into account as indexes for evaluating the signal quality.

[Step S202: Recording User Data]

The disk controller 115 sets the optimum recording power stored in the predetermined register and performs a recording operation onto a disk. The disk controller 115 performs intermittent recording or continuous recording under instructions from a higher-level command.

[Step S203: Continuing the Recording?]

In this step, it is determined whether to continue the recording. If an instruction to continue the recording operation from the higher-level command is provided, the process transitions to step S205. If an instruction to stop the recording is provided, the process transitions to END, to terminate the processing.

[Step S204: Searching for the Recording Power?]

The disk controller 115 determines whether or not it is necessary to search for the recording power again. For example, if a predetermined period has passed after the optimum recording power is obtained in step S201, it is determined that the search for the recording power is necessary. Alternatively, if a temperature change of a predetermined amount or more is observed after the optimum recording power is obtained, it is determined that the search for the recording power is necessary. In this manner, step S204 transitions to step S205 if it is necessary to search for the recording power again. If it is not necessary to search for the recording power again, the process returns to step S202, to continue the recording operation.

[Step S205: Obtaining the Reproduced P Value (PN)]

In this step, processing of reproducing the data recorded on the disk to determine the β value is performed. Here, immediately after the completion of the recording operation, the last recorded data recorded just now is reproduced to obtain the β value. The disk controller 115 stores the obtained value βN in a predetermined register. The controller 115 includes a plurality of registers and calculates β by data accesses to and operations on the registers in question.

[Step S206: Judging the Amount of Change of the β Value]

Here, it is detected whether or not the amount of change of the β value exceeds a predetermined value, to determine whether to carry out the tilt adjusting in the next step S207.

For example, the disk controller 115 obtains the magnitude of the differences between the βo value and the βN value stored in the predetermined registers, and compares the magnitude with a predetermined threshold (a Th value) as:

|βN−βo|>Th value.

If it is determined that the amount of change of the β value |βN−βo| is larger than the Th value, the process transitions to step S207.

Otherwise, the process returns to step S201, to set the recording power. At this point, the recording power is determined so that the difference from the βo is compensated for according to the βN value obtained in step S205.

The Th value in this embodiment is set to 5[%], for example. According to this setting, the process transitions to step S207, if the difference between the βo value and the βN value exceeds 5%.

The predetermined value in determining whether to transition to step S207 is not limited to the absolute value of the difference between the βN value and the βo value, which is the amount of change of the β value. Rather, the ratio between the βN value and the βo value, or only the sign of the βN value may be checked.

[Step S207: Carrying Out the Tilt Adjusting]

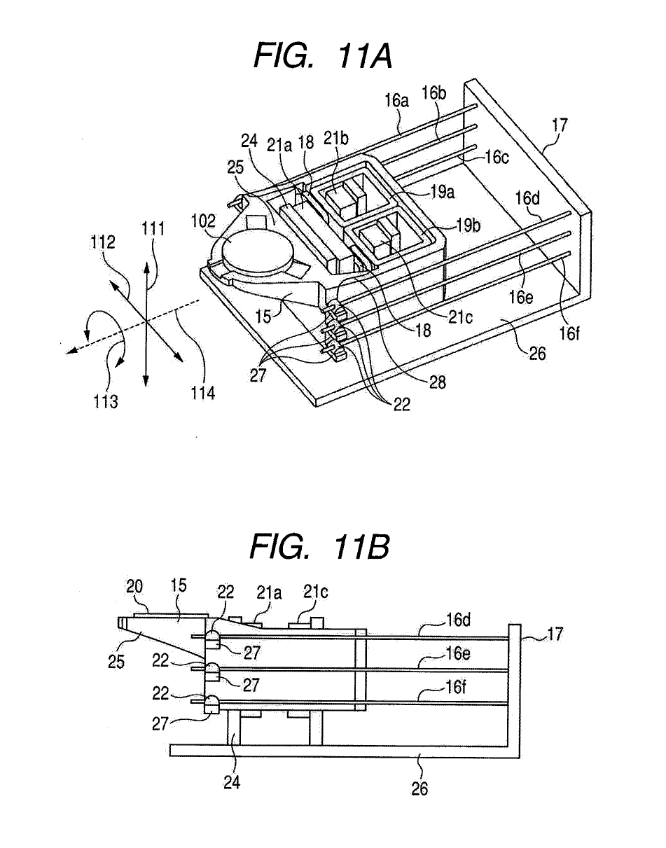

The tilt adjusting will be described with reference to the drawings. FIGS. 11A and 11B illustrate the structure of the actuator 130, where FIG. 11A is a perspective view and FIG. 11B is a side view. The actuator 130 includes a fixed section 26 and a movable section 25. The fixed section 26 includes permanent magnets 21a, 21b, and 21c, a yoke 24, and a supporting base 17. The movable section 25 includes the objective lens 102, focus coils 19a and 19b, a tracking coil 18, and a lens holding member 15 holding these components.

Wires 16a, 16b, 16c, 16d, 16e, and 16f are linear, and have elasticity and high conductivity. One end of each wire is fixed on the supporting base 17, and the other end is fixed on sides of the lens holding member 15, to allow the movable section 25 to be displaced to a focus direction 111, a tracking direction 112, and a radial tilt direction 113 with respect to the optical disk. In FIG. 11A, reference numeral 114 denotes a tangential direction.

The ends 28 of the windings of the focus coils 19a and 19b and the tracking coil 18 are connected to the wires 16a, 16b, 16c, 16d, 16e, and 16f by terminals 27 provided on the sides of the lens holding member 15.

The actuator driver 113 in FIG. 1 supplies a focus driving signal to the focus coils 19a and 19b, and a tracking driving signal to the tracking coil 18, based on the focus error signal or the tracking error signal. The actuator 130 drives the movable section 25 in three directions with respect to the optical disk, by electromagnetic power occurring between these driving signals, and a magnetic flux generated by the permanent magnets 21a, 21b, and 21c. The three directions include the focus direction between the optical disk and the objective lens, the tracking direction orthogonal to the track grooves, and the radial tilt direction, in which the objective lens is radially tilted by giving thrusts in different directions to the two focus coils 19a and 19b, respectively. The focus driving signal is a current signal supplied to the focus coils 19a and 19b for setting the focus error signal to a predetermined level.

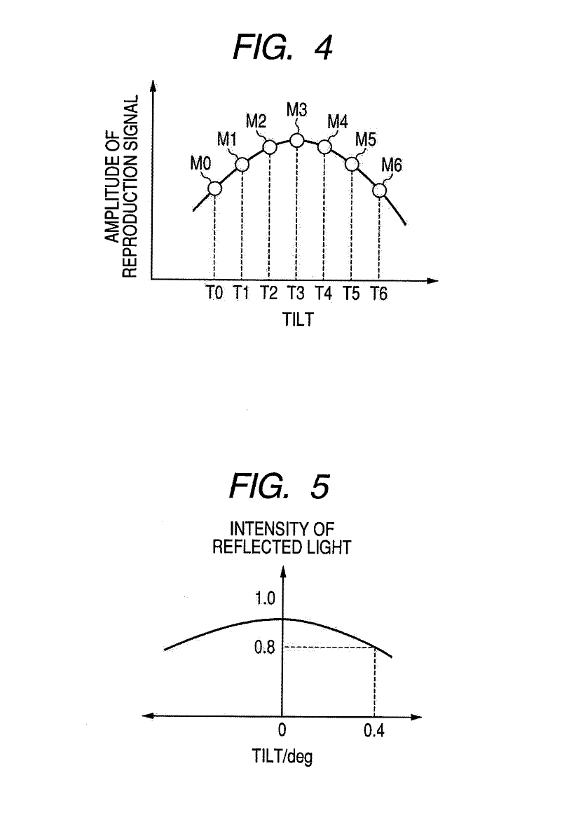

The tilt adjusting S207 is a step of compensating for the tilt of the objective lens with respect to a warp of the disk, and is performed by the disk controller 115. FIG. 4 is a diagram describing the tilt adjusting. In FIG. 4, the abscissa indicates tilt setting values of the objective lens, and the ordinate indicates amplitude values of the reproduction signal. Specifically, the objective lens 102 is tilted by the actuator 103 in the range of several levels to the right and left of the disk tangential direction at the center, for example from T0 to T6. For the tilts T0, T6, . . . applied to the objective lens, amplitude values M0, M1, . . . of the reproduction signal are obtained respectively. Then, a tilt at which the reproduction signal as the maximum amplitude value is set. As the tilt between the center (optical axis) of the objective lens and the disk surface increases, the aberration of the optical beam spot increases and, therefore, the amplitude of the reproduction signal decreases. In the example of FIG. 4, the tilt T3, at which the amplitude of the reproduction signal is the maximum M3, is set. The tilt range for the tilt adjusting needs to reach the extent that provides a sufficient amplitude variation required for searching for the maximum amplitude of the reproduction signal. Another effective way of searching for the maximum amplitude value is as follows. For example, in FIG. 4, T0 and T6, which are tilts corresponding to approximately the same amplitudes M0 and M6, are determined, and the tilt is set to the center value between the tilt angles of T0 and T6.

After carrying out the tilt adjusting S207, the process returns to step S201 to obtain the optimum recording power. This is because the tilt adjusting S207 has changed the effective intensity of the light beam spot to cause a mismatch of the optimum value of the recording power.

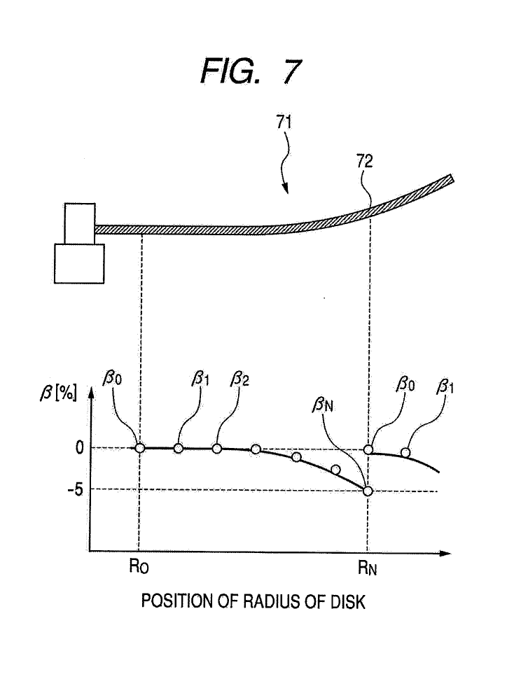

Here, the overview of the tilt adjusting according to this embodiment will be described as a supplement with reference to FIG. 7. FIG. 7 is a diagram illustrating a tilt in a disk sectional view 71 and the dependence of the β value of the reproduction signal on the radial position. In FIG. 7, the optimum recording power Po at a radius Ro is obtained (step S201). The disk controller obtains the βN value at predetermined intervals, for example, in every intermittent driving cycle, and updates the β value in the predetermined register as β1, β2, and so on (repeats steps S206 to S202). In this example, at an outer radius of the disk, the β value decreases by the effect of a tilt 72. When condition:

|βN−βo|>5[%]

is true at an outer radius RN, the tilt adjusting is carried out (step S207). The βN value is continuously obtained and the recording power Po is set again at the radial position RN. Thereafter, the recording operation is continued, while the amount of change of the β value of the reproduction signal is monitored in this manner.

Thus, the first operation flow according to the present invention has been described in detail. By monitoring the amount of change of the reproduced β value in step S206, the tilt adjusting can be carried out with appropriate timing in recording.

Generally, the occurrence of a tilt (warp) is unpredictable for the system, because the tilt depends on a rapid change in temperature/humidity inside the apparatus, the maintenance state of the disk itself, or characteristics of the composition of the disk. Especially, in the case when high-quality video data transmitted in real time is recorded, and the code is large in amount, the recovery of the recording involving verification is difficult. In this embodiment, the tilt adjusting in recording can be performed with appropriate timing. That is, conflicts of recording tasks can be restrained, and the tilt adjusting can be carried out by catching the occurrence of a tilt without fail. This significantly contributes to the increase of the reliability of the recording-reproducing system.

In addition, by carrying out the tilt adjusting, a coma aberration itself due to the disk tilt is decreased. This is completely different from techniques of improving the recording quality by increasing or decreasing the laser power as described in the conventional art (such as Japanese Patent Application Laid-Open No. 2001-23174). That is, the present invention can also reduce temperature changes inside the apparatus as compared to the conventional art.

### Second Embodiment

### Tilt-Adjusting Flow in Optical Recording-Reproducing Apparatus 100

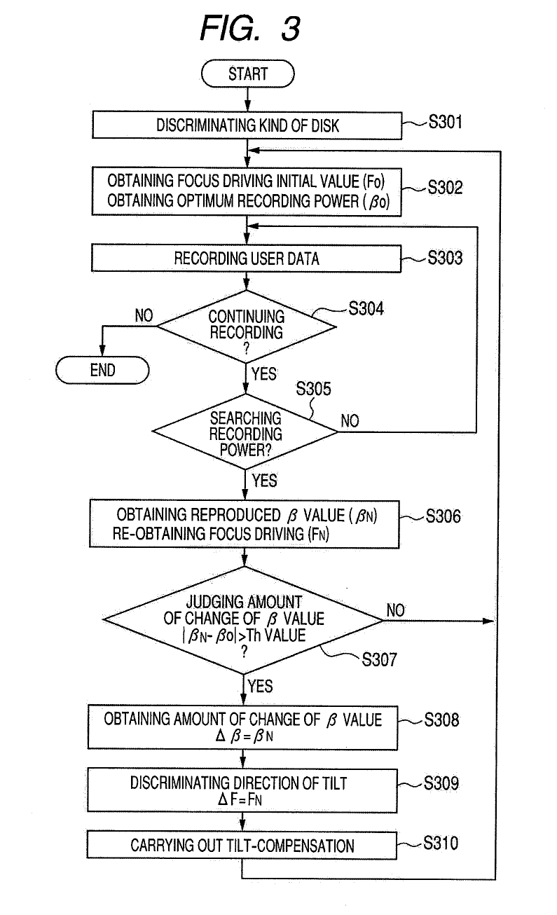

FIG. 3 is a flowchart illustrating second tilt adjusting according to the present invention. In this embodiment, the amount of tilt adjusting can be determined by monitoring the amount of change of the β value of the reproduction signal. A specific adjusting flow will be described with reference to FIG. 3.

[Step S301: Discriminating the Kind of Disk]

In this step, the kind of disk is discriminated. For example, a phase-change RW type or a write-once R type is discriminated. At the same time, a manufacturer ID is read from disk information to identify a disk manufacturer as well. The detected disk manufacturer information will be used for identifying a characteristic of the recording film of the disk to be described later.

[Step S302: Obtaining an Optimum Recording Power Initial Value (Po) and Obtaining a Focus Driving Signal Initial Value (Fo)]

This step is a process of obtaining an optimum recording power initial value (Po) for the disk and a focus driving signal initial value (Fo).

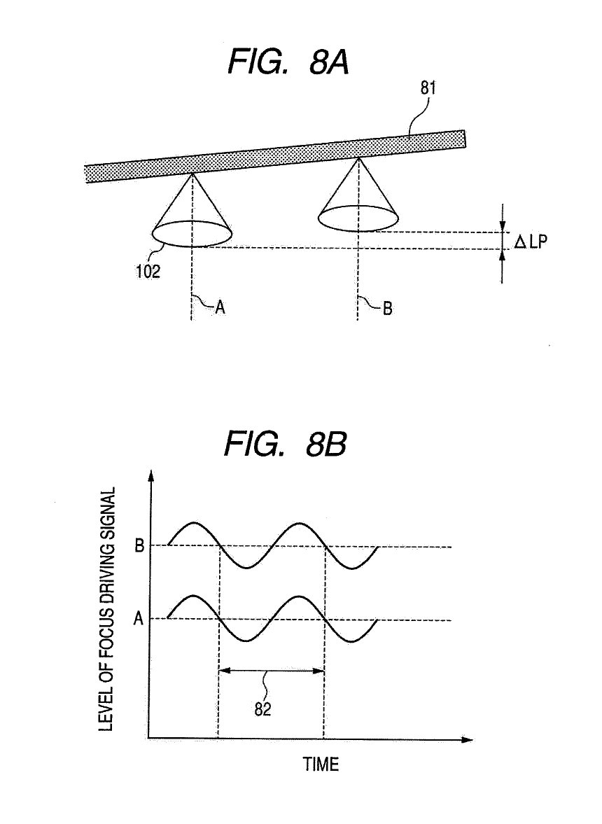

The process of obtaining the optimum recording power is as described in the first embodiment. Here, the process of obtaining the focus driving signal initial value (Fo) will be described with reference to the drawings. FIGS. 8A and 8B illustrate positions of the objective lens at different radial positions A and B on the disk, and the temporal transition of the focus driving signal of the actuator 103.

Since the focus driving signal follows surface runout of the disk 81, the focus driving signal fluctuates up and down in synchronization with a disk rotation cycle 82. In addition the average level of the focus driving signal changes according to a change in the relative lens position of the objective lens 102 to the OPU 120. FIGS. 8A and 8B illustrate that the disk is warped at B, so that the relative position of the objective lens 102 to the OPU is more distant by βLP at the radial position B than at the radial position A. The average level of the focus driving signal correspondingly increases, resulting in B>A.

In this step, the average level (Fo) of the focus driving signal is obtained at the same time as obtaining the optimum recording power initial value (Po). The obtained focus driving signal initial value (Fo) is stored in a predetermined register. Thereafter, the direction of the change, i.e., whether the objective lens has approached the disk surface from the OPU 120 or rather, has moved away from the disk surface, can be known by monitoring a change in the average level of the focus driving signal.

[Step S303: Recording User Data]

The disk controller 115 sets the optimum recording power stored in the predetermined register and performs a recording operation onto the disk. The disk controller 115 performs intermittent recording or continuous recording under instructions from a higher-level command.

[Step S304: Continuing the Recording?]

In this step, it is determined whether to continue the recording. If an instruction to continue the recording operation from the higher-level command is provided, the process transitions to step S305. If an instruction to stop the recording is provided, the process transitions to END, to terminate the processing.

[Step S305: Searching for the Recording Power?]

The disk controller 115 determines whether or not it is necessary to search for the recording power again. For example, if a predetermined period has passed after the optimum recording power initial value (Po) is obtained in step S302, it is determined that a search for the recording power is necessary. Alternatively, if a temperature change of a predetermined amount or more is observed after the optimum recording power initial value (Po) is obtained, it is determined that the search for the recording power is necessary. In this manner, S305 transitions to step S306 if it is necessary to search for the recording power again. If it is not necessary to search for the recording power again, the process returns to step S303, to continue the recording operation.

[Step S306: Obtaining the Reproduction Signal β Value (βN) and Obtaining Again the Focus Driving Signal (FN)]

This step is a process of obtaining again the β value of the reproduction signal, the average value of the focus driving signal, and the laser temperature, so that the same operation as in S302 is performed. However, the disk controller 115 stores the obtained reproduction signal βN value and focus driving signal FN in a register different from the one for the reproduction signal βo value and the focus driving signal initial value Fo obtained in step S302. That is, every time it is determined that the searching is necessary in step S305, these values are stored as PN and FN in the register and updated.

[Step S307: Judging the Amount of Change of the β Value]

The disk controller 115 obtains the magnitude of the difference between the Po value and the βN value stored in the predetermined registers and compares the magnitude with a predetermined threshold (a Th value) as:

|βN−βo|>Th value.

If it is determined that the amount of change of the β value |βN−βo| is larger than the Th value, the process transitions to step S308.

Otherwise, the process returns to step S302, to update the recording power. At this point, the recording power is determined so that the difference from the βo is compensated for according to the βN value obtained in step S306.

The Th value in this embodiment is set to 5[%], for example. According to this setting, the process transitions to step S308, if the difference between the βo value and the βN value exceeds 5%.

The determination as to whether to transition to step S308 may not be based on only the absolute value of the difference between the βN value and the βo value, which is the amount of change of the βvalue. Rather, the ratio between the βp value and the βN value, or only the sign of the βN may be checked.

[Step S308: Obtaining the Amount of ΔP of the β Value]

The disk controller 115 obtains the amount of change Δβof the β value of the reproduction signal as:

Δβ-βN-βo.

[Step S309]: Obtaining ΔF for Discriminating the Direction of the Tilt]

The disk controller 115 compares the register values of the average level FN and Fo of the focus driving signal to obtain the direction of the tilt as follows:

if ΔF=FN−Fo>0, the direction such that the distance between the disk surface and the laser light source increases, and

if ΔF−FN−Fo<0, the direction such that the distance between the disk surface and the laser light source decreases.

[Step S310: Carrying Out the Tilt Compensation]

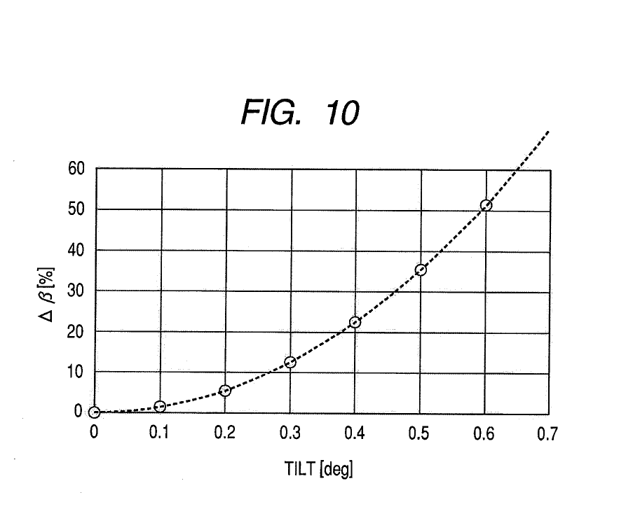

FIG. 10 illustrates the relationship between the amount of change Δβ of the β value of the reproduction signal and the tilt-compensation value in the optical recording-reproducing apparatus in this embodiment. The disk controller 115 carries out the tilt compensation based on the result of detecting Δβ and a compensation table in FIG. 10. An example is as follows:

When Δβ=5% and ΔF>0, the tilt is set to 0.2 degrees according to the tilt-compensation table in FIG. 10, and the objective lens is moved by the actuator in the direction of approaching the disk. The disk controller 115 includes a plurality of registers and calculates Δβ and ΔF by data accesses to and operations on the registers in question.

In this embodiment, the tilt compensation can be carried out by uniquely determining the amount of tilting to vary, based on the amount of change of the β value of the reproduction signal. Typically, searching for the best tilt position by varying the actuator requires several hundred mS. This embodiment eliminates such a tilt-adjusting process and advantageously carries out the compensation in a single step by determining, in advance, the amount of tilting to vary.

Thus, the tilt compensation can be carried out by catching the occurrence of a tilt without fail. This significantly contributes to the increase of the reliability of the recording-reproducing system.

In addition, by carrying out the tilt adjusting, a coma aberration itself due to the disk tilt is decreased. This is completely different from techniques of improving the recording quality by increasing or decreasing the laser power as described in conventional art (such as Japanese Patent Application Laid-Open No. 2001-23174). That is, the present invention can also reduce temperature changes inside the apparatus as compared to the conventional art.

The tilt adjusting of the present invention relates top the mechanism for adjusting a tilt in the direction of the disk radius (called a radial tilt). However, the tilt adjusting is not limited to this direction, but may be carried out in the tangential direction. While the exemplary embodiments of the present invention have been described in terms of hardware-based configurations, it is to be understood that the spirit of the present invention is not constrained by this, but may be implemented by program processing only in software.

While the present invention has been described with reference to exemplary embodiments, it is to be understood that the invention is not limited to the disclosed exemplary embodiments.

1. An optical recording-reproducing apparatus comprising:
a laser light source for emitting a luminous flux;
an objective lens for concentrating the luminous flux emitted from the laser light source onto a disk medium;
an actuator for controlling the position of the objective lens;
a tilt-adjusting circuit for adjusting a tilt of the objective lens with respect to the disk medium;
a circuit for determining laser power for recording a recording mark on the disk medium; and
a circuit for detecting symmetry of the recording mark based on light reflected from the disk medium,
wherein, in recording, the tilt of the objective lens is adjusted by the tilt-adjusting circuit if an amount of change of the symmetry of the recording mark is larger than a predetermined value and, after the tilt adjusting, the circuit determines an optimum recording power for determining laser power.

2. (canceled)

3. The optical recording-reproducing apparatus according to claim 1, further comprising a circuit for obtaining a focus driving signal for the disk medium,
wherein a direction of a tilt of the disk medium is detected based on the focus driving signal, and the tilt-adjusting circuit adjusts the tilt of the objective lens based on the detection.

4. The optical recording-reproducing apparatus according to claim 1, further comprising a memory for holding information in order to cause recording of the recording mark on the disk medium and reproduction of the recording mark from the disk medium to be intermittently operated,
wherein the circuit for detecting the symmetry of the recording mark detects the symmetry in synchronization with the intermittent operation.
